(19) United States
(12) Patent Application Publication
(10) Pub. No.: US 2003/0059521 A1
(43) Pub. Date: Mar. 27, 2003

(54) Additive mixing method reducing to a minimum additive segregation and migration

(76) Inventors: Christian Gancet, Lons (FR); Jean-Paul Chambrette, Antony (FR); Myriam Gourmand, Paris (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/149,757

(22) PCT Filed: Dec. 11, 2000
(86) PCT No.: PCT/FR00/03468

(51) Int. Cl. B01F 3/20

(52) U.S. Cl. 427/2.3; 427/212

(57) ABSTRACT

The invention concerns a method for preparing a composition containing a superabsorbent and antimicrobial powder acting as deodorizing additive. The inventive method consists in an oven drying of a mixture of the elements of the composition, at a temperature higher than 5° C. than the additive melting point.

The present invention relates to the field of superabsorbent polymers for preparing sanitary articles capable of absorbing and retaining bodily fluids, and more particularly to superabsorbent polymers that are reinforced against odors. The invention in particular describes a supplementation process that prevents the sedimentation of additives.

For the purposes of the invention, superabsorbent polymers, denoted hereinbelow as SAP, are polymers which result from the polymerization with partial crosslinking of ethylenically unsaturated water-soluble monomers, in particular acrylic and methacrylic acids and alkali metal salts thereof, whether obtained by a solution polymerization, bulk polymerization or reverse-suspension polymerization process. These polymers have a very large capacity for absorbing and retaining water and aqueous solutions, and are nowadays widely available commercially in the form of powders with particle sizes remaining between 100 and 800 μm. The literature is very rich in this area; reference may be made, for example, to EP-A-0 312 952 or EP-A-0 441 507.

The industry of superabsorbents (SAPs) is very often confronted with a need to add an additive. Specifically, to satisfy market demands, it is often necessary to add other properties to these products in addition to their absorption and retention performance qualities. For example, when the absorbent article in place is impregnated with bodily fluids, in particular urine, it gives off powerful and unpleasant odors. Among these are dominant ammoniacal odors due to ammonia arising from the hydrolysis of urea by the bacterial ureases present on the skin and in the digestive tract.

With the aim of eliminating these odors, it is necessary to add an antimicrobial additive to the composition. In this case, such a compound is generally termed an antiodor agent or additive.

Various techniques have been used to add an antiodor additive to SAPs. Thus, WO 98/20915 and EP 739 635 describe mixtures containing, respectively, zeolites and borax. These mixtures are prepared in solid form as a powder-powder mixture.

U.S. Pat. No. 4,842,593 describes diapers containing SAP with pad agents and a nontoxic, nonirritant and nonvolatile antimicrobial agent.

The antimicrobial agent is preferred in solid form rather than in liquid form as an alcohol-based solution. In the latter case, it is not incorporated into the SAP, but rather into the top sheet in contact with the skin.

The process most commonly used for adding one product to another is solid state mixing known as incorporation. Specifically, incorporation is an efficient process for providing an existing industrial product with new functions. Many examples may be mentioned, such as the various additives (colorants, pigments, fillers, etc.) that are introduced into polymer powders such as PVC, PE, PP and polyamide before extrusion.

However, this type of supplementation generally leads to a segregation of the compounds, the densest compound having a tendency to sediment, and doing so all the more when the morphology and size distribution of the 2 types of particles are very different. This problem is all the more crucial when the superabsorbent powders may be stored for several months and are subjected to transportation conditions which may promote sedimentation (rough sea, bumpy road surface, etc.).

EP 739 635 and WO 98/20915 propose a solution based on modifying the particle size to avoid the separation and sedimentation.

The invention presented herein is intended to solve this phenomenon of segregation in the case of an organic additive with a melting point<200° C.

The solution proposed is based on a process for preventing the phenomena of sedimentation and of nonuniformity in superabsorbents mixed with organic compounds in solid form. This process is simpler and less expensive than an incorporation into the SAP by spraying, impregnation or immersion using an aqueous or nonaqueous liquid solution, since there is no spraying step or evaporation step.

The process of the invention consists in heating the SAP/additive mixture, after homogenization in solid form, to a temperature between the melting point of the additive and 200° C. and preferably at least 5° C. above the melting point of the product. The SAP particles then become coated with the molten additive, which subsequently prevents any phenomenon of segregation between the SAP and the additive and of migration of the additive.

According to the invention, the antiodor additive is an antimicrobial agent such as Triclosan described in “The Index of Antimicrobials; by Michael and Irene Ash; published by Gower—1996”.

The process of the invention is entirely suitable for incorporating into SAPs Irgasan DP300, which is a particular formulation of Triclosan. Specifically, in the particular case of Irgasan DP300, this compound is in the form of rods with a mean particle size of 200 μm, whereas the SAP particles generally used in hygiene (of the gel process or reverse-suspension type) are between 100 and 800 μm in diameter (preferably centered around 400-500 μm) and are in the form of stones (gel process) or aggregated beads (reverse suspension). Thus, despite a density in the region of that of SAP particles, segregation between the additive and the matrix is favored.

This general process is described more particularly in the case of the supplementation of Triclosan into SAPs, in order to obtain an antiodor SAP. Since this additive is highly efficient, the optimum concentration to be introduced is between 0.01% and 0.5% (preferably about 0.05%). It is thus very important to eliminate any risk of segregation in order to avoid variations in metering out the Triclosan in the final application (baby or adult diapers and sanitary towels). It is also important to control any; risk of migration of the additives toward the skin of the babies or adults.

According to one embodiment of the invention, the required amount of the antiodor agent is added directly to the SAP, and according to another embodiment an SAP/additive masterbatch containing approximately 5% by weight of additive is first prepared and the masterbatch is then diluted with a crude SAP so as to reach the additive content required for the application.

Another subject of the invention is an SAP containing from 0.01% to 0.5% by weight of antibacterial additive and prepared according to the process described above. Another subject of the invention is the use of SAPs in hygiene articles such as baby diapers, and also the hygiene articles themselves.

In order to prepare an SAP containing 0.05% by weight of Triclosan according to the invention, it is possible to proceed in the following way:

1. A masterbatch containing 5% Triclosan is first prepared according to the following steps:

a) homogenization of the SAP+Triclosan mixture in a mixer.

b) dynamic or static incubation in heating drums such as a jacketed mixer or a mixer followed by a heating container (the initial homogenization may take place in these drums or in another mixer) or in any other manner (for example by beating in hot air at a temperature above the melting point of the additive, denoted as Tf, thus allowing mixing and melting of the additive) or other types of apparatus which may combine these two actions, or static (in the form of bags of masterbatch stacked on a pallet).

The incubation temperature must be at least 5° C. above the melting point of the organic additive. It is chosen as a function of the amount to be treated and of the system used and controlled by means of probes placed in the core of the system. In the case of Irgasan DP300 (Tf=57±1° C.), it is preferable to heat the SAP+additive system to at least 63° C., or even 65° C. However, it is necessary for the incubation temperature to be below the decomposition temperature of the product. The swelling efficiencies of SAPs are not affected by the incubation (at 200° C., SAP may be incubated for about 1 hour and for much longer at lower temperatures).

Needless to say, the incubation time depends on the temperature difference between the incubation temperature and the melting point, and also on the amount of product incubated and the product itself (on the basis of its thermal conductivity). The use of a master batch makes it possible to reduce the amount of product to be incubated and consequently the incubation time.

A rapid test makes it possible to estimate the incubation time: an observation under a magnifying lens makes it possible to confirm the disappearance of the additive particles (rods in the case of Irgasan DP300).

2. Cooling of the system by returning to room temperature or by controlled cooling, i.e.

statically

by continuing the mixing if the incubation was carried out dynamically

After melting, the organic additive remains supercooled for a certain period, that is to say that it does not recrystallize immediately when the temperature falls below its melting point.

The mode of cooling, static or dynamic, has an effect only on the “consistency” of the product after incubation. The reason for this is that an SAP with a high concentration of additive (in the case of the masterbatch) cooled statically (on a pallet) will have a tendency to form aggregates (these aggregates are easy to break down and are readily disintegrated by an efficient subsequent mixing). However, it is preferable for the product to cool with stirring in order to avoid this aggregation phenomenon, which may be observed with static cooling.

3. Dilution in a 1:100 ratio of the masterbatch in crude SAP.

The examples that follow illustrate the invention without limiting its scope.

### EXAMPLES

1.) Evaluation of the sedimentation with SAPs supplemented with 5% Triclosan, with and without incubation

Description of the Test

A Plexiglas tube of height 42.5 cm and diameter 3 cm, closed at both ends with rubber stoppers, is filled with 150 g of SAP supplemented with 5% Triclosan. This tube (filled to ⅔) is then placed vertically in a Retsch tamper and is subjected to 10 minutes of vibrations (cycles of 10 s of vibration and 3 s of rest) of amplitude 1.2 mm in order to promote sedimentation of the mixture.

About 15 g of SAP are then recovered from the top and bottom of the tube in order to determine the Triclosan concentration in the SAP at the ends of the tube.

Sample Preparation Conditions

Without incubating: dry-mixing for 2 hours of SAP HP200+5% Triclosan using a turbomixer.

With static incubation: dry-mixing for 2 hours of SAP HP200+5% Triclosan using a turbomixer, followed by incubation at 75° C. for 1 hour. The sample is then returned to room temperature until cooling is complete and the Triclosan has recrystallized. The aggregates are removed coarsely by stirring with a spatula and the sample is then homogenized for 2 hours with a turbomixer.

With dynamic incubation: dry-mixing for 2 hours of SAP HP200+5% Triclosan, using a turbomixer. 400 g of this mixture are introduced into a 1 liter jacketed glass reactor fitted with a paddle stirrer. The control temperature of the thermostatically maintained bath is set at 80° C. and the stirring speed is set at 350 rpm. After heating for 20 minutes, the reactor is cooled. Stirring is continued for 30 minutes to allow the Triclosan time to recrystallize.

Extraction of the Triclosan and Assay by UV

The UV spectrum of the Triclosan comprises 2 peaks at lambda=202.5 and 282 nm with different extinction coefficients. Methods A and B described below differ in the size of sample and the choice of wavelength. Method B will be preferred since the larger sample size makes it possible to limit the errors due to sampling and, moreover, the absolute ethanol used as solvent has no absorbance at the wavelength used.

Method A

For Triclosan concentrations of about 5%, 1 g of supplemented SAP is added to 300 g of absolute ethanol and the solution is stirred at 500 rpm for 2 hours and then subjected to ultrasound for 15 min. 5 g of the supernatant are then diluted in 200 g of absolute ethanol in order to obtain a final concentration which is measurable by spectrophotometry (absorbance of between 0.5 and 1).

The Triclosan concentration in absolute ethanol solutions is determined by UV spectrometer. A calibration curve was then established at the wavelength lambda=202.5 nm using control solutions with concentrations of between 1 and 8 ppm. The supernatant is introduced into the measuring cells using a syringe and a filter (to avoid introducing dust). The reference used for the measurements of Triclosan extracted from SAP is the supernatant obtained according to the same protocol with nonsupplemented SAP (identical extraction times and dilution times).

Method B

For Triclosan concentrations of about 5%, 10 g of supplemented SAP are added to 150 g of absolute ethanol and the solution is stirred at 500 rpm for 2 hours and then subjected to ultrasound for 15 min. 1 g of the supernatant is then diluted in 100 g of absolute ethanol in order to obtain a final concentration which is measurable by spectrophotometry (absorbance of between 0.5 and 1).

The Triclosan concentration in absolute ethanol solutions is determined by UV spectrometer. A calibration curve was then established at the wavelength lambda=282 nm using control solutions with concentrations of between 10 and 60 ppm. The supernatant is introduced into the measuring cells using a syringe and a filter (to avoid introducing dust). The reference used for the measurements of Triclosan extracted from SAP is the supernatant obtained according to the same protocol with nonsupplemented SAP (identical extraction times and dilution times).

Results

The results are the average of a minimum of two extractions, each being assayed at least twice.

Triclosan concentration
in the SAP (%)

| | Method A | Method B |
|---|---|---|
| HP200 + 5% Triclosan without | 2.5 | 2.6 |
| incubation top fraction | | |
| HP200 + 5% Triclosan without | 9.8 | 11.2 |
| incubation bottom fraction | | |
| HP200 + 5% Triclosan with | 5.3 | — |
| static incubation top fraction | | |
| HP200 + 5% Triclosan with | 4.9 | — |
| static incubation bottom fraction | | |
| HP200 + 5% Triclosan with | 5.2 | 5.2 |
| dynamic incubation top fraction | | |
| HP200 + 5% Triclosan with | 4.6 | 4.8 |
| dynamic incubation bottom fraction | | |

It may be noted that very strong sedimentation of the additive is observed when the mixture SAP+Triclosan is not incubated. On the contrary, strong vibrations do not modify the distribution of the antibacterial agent in the SAP when the mixture has been incubated.

2) Evaluation of the antibacterial and antiodor performance qualities of SAPs supplemented with 0.05% Triclosan, with and without incubation

Preparation of the Urine

The test may be performed either on real urine or on a synthetic urine. In the case of real urine, 4 days before the test, a collection of urine is made with an indication to abstain for individuals taking medicinal products or antibiotics. For the synthetic urine, it suffices to prepare it at the time of use, according to the composition below:

Per 1 l H₂O

| | | | |
|---|---|---|---|
| Urea | 25 g | K₂SO₄ | 4 g |
| NaCl | 9 g | (NH₄)₂SO₄ | 2.5 g |
| MgSO₄ | 0.6 g | Glucose | 5 g |
| Ca(OCOCH₃)₂ | 0.7 g | Yeast extract | 5 g |

Test Panel

Preparation of the Inoculum

The inoculum is prepared with 20 ml of real or synthetic urine, 0.5 g of urea and either 2 g of soiled fluff (already having an ammoniacal odor) or the desired bacterial strain(s). The mixture is incubated for 2 days, during which time the urine collected is stored at 4° C.

At the time of the test, the inoculum has a pronounced odor, which is a sign of satisfactory growth. In the case of the isolated strains, the bacterial concentration* is measured, in order to achieve a reproducible inoculation. * expressed in cfu/ml (colony forming units/ml)

Preparation of the Samples n×8 cylindrical polyethylene hermetic dishes are prepared, n being the number of products to be tested. Each series of 8 dishes is referenced with a random three-figure number. 0.5 g of cellulose (fluff) and 0.3 g of superabsorbent polymer dispersed or otherwise in the bulk, to which the antiodor product(s) to be tested has (have) been added or otherwise, are deposited in each dish.

30 ml of synthetic urine enriched with the desired amount of inoculum are poured onto each pad. The dishes are closed and incubated overnight at 37° C. in an oven.

Evaluation of the Odor

At the time of the test, the dishes are removed from the oven and given at random to the members of the panel who have to grade the odor between 1 and 6. The absence of odor of NH₃ is graded 1, and a very strong odor is graded 6.

The results are collated and the average of the grades obtained is calculated for each test product.

Counting the Bacteria

After evaluating the odor, the microorganisms are counted for each type of sample. To do this, the samples are diluted with 70 ml of sterile water and counting is carried out using Millipore plates. The result is expressed in cfu/ml (colony forming units/ml).

### Example

Synthetic urine

Inoculation at 10⁴ cfu/ml

| | Average panel | Bacteria, |
|---|---|---|
| Sample | grade (1-6) | cfu/ml |
| HP200 control | 4.88 | TNTC* |
| HP200 + 0.01% Irgasan | 1.25 | 72-100 |
| With incubation | | |
| HP200 + 0.01% Irgasan | 1.13 | 80-100 |
| Without incubation | | |
| HP200 + 0.05% Irgasan | 1.5 | 35-40 |
| With incubation | | |
| HP200 + 0.05% Irgasan | 1.38 | 55-60 |
| Without incubation | | |
| HP200 + 0.1% Irgasan | 1.25 | 5-15 |
| With incubation | | |
| HP200 + 0.1% Irgasan | 1.50 | 0-1 |
| Without incubation | | |

*too numerous to count

NH₃ Test

Inoculation of the Synthetic Urine

A tube of freeze-dried Proteus mirabilis bacteria (Reference LMG 2954—freeze-dried bacteria stored at 4° C.) is introduced into 333 g of synthetic urine (i.e. the equivalent of 3 doses per liter).

Preparation of the Samples

n×2 100 cm³ conical flasks (19/26 ground joint) comprising a Torion joint (diameter 8 on 19/26 ground joint and PTFE leaktight joint) are prepared, n being the number of test products, into which are introduced 0.5 g of fluff and 0.5 g of SAP supplemented with 0.05% Triclosan (incubated or otherwise), dispersed or otherwise in the mass of fluff. 33 g of inoculated synthetic urine are poured onto each pad. The flasks are then sealed by introducing a ready-to-measure dosimeter tube (GASTEC Tube—passive dosi-tube NH₃-reference Prolabo 02 436 112) and then placed in an 40° C. The coloration of the assay tube makes it possible to determine the NH₃ concentration (in ppm) in the flask according to the following formula:

Tube reading×0.8/number of hours of incubation

The value 0.8 of the coefficient corresponds to an incubation temperature of 40° C.

Results

NH₃ assay (ppm)

| | | HP200 + 0.05% | HP200 + 0.05% |
|---|---|---|---|
| | | Triclosan | Triclosan |
| Time | Blank | with | without |
| (hours) | (fluff) | incubation | incubation |
| 0 | 0 | 0 | 0 |
| 1 | 0 | 0 | 0 |
| 2 | 5 | 0 | 0 |
| 3.5 | 6 | 0 | 0 |
| 4 | 7 | 0 | 0 |
| 5 | 16 | 0 | 0 |
| 6 | 60 | 0 | 0 |
| 7 | off scale | 1 | 1 |
| 8 | off scale | 1 | 1 |
| 9.5 | off scale | 1 | 1 |
| 24 | off scale | 1 | 1 |

The SAP HP200+0.05% Triclosan systems are manufactured using an HP200+5% Triclosan masterbatch diluted 100-fold in SAP HP200.

HP200 +0.05% Triclosan system without incubation: the masterbatch used is that prepared without incubation (see description in the above paragraph). The dilution in HP200 takes place with stirring for 2 hours using a turbomixer.

HP200+0.05% Triclosan system with incubation: the masterbatch used is that prepared with static incubation (see description in the above paragraph) The dilution in HP200 is carried out with stirring for 2 hours using a turbomixer.

It may be noted that there is no significant difference in the antibacterial and antiodor properties of the SAP when the masterbatch is incubated or otherwise (under the conditions in which the nonincubuated system was homogenized to avoid any sedimentation and consequently any variation in Triclosan concentration).

1. A process for coating particles of superabsorbent polymers, known as SAPs, with an antimicrobial additive, which consists in:
a- mixing and blending a composition containing from 90% to 99.99% by weight of polymer and from 0.01% to 10% by weight of at least one antimicrobial.additive,
b- incubating until the additive has totally melted at a temperature between the melting point of the additive and 200° C.

2. The process as claimed in claim 1, characterized in that said composition consists of from 0.01% to 5% by weight of additive.

3. The process as claimed in claim 1 or 2, characterized in that the incubation temperature is at least 5° above the melting point of the additive.

4. The process as claimed in one of the preceding claims, characterized in that the mixing is carried out in the solid state.

5. The process as claimed in one of the preceding claims, characterized in that the incubation is carried out in static mode.

6. The process as claimed in one of claims 1 to 4, characterized in that the incubation is carried out in dynamic mode.

7. The process as claimed in one of the preceding claims, characterized in that the additive is Triclosan.

8. A superabsorbent polymer composition as may be obtained as claimed in any, one of the preceding claims.

9. Use of the superabsorbent polymer compositions of claim 8, optionally diluted so as to bring the content of antimicrobial additive to a value of between 0.01% and 0.5% by weight, to prepare sanitary articles capable of absorbing and retaining bodily fluids.

10. A sanitary article such as a diaper for babies and adults and for feminine hygiene, containing the SAPs of claim 8.
